(19) United States
(12) Patent Application Publication
(10) Pub. No.: US 2006/0062618 A1
(43) Pub. Date: Mar. 23, 2006

(54) Printing apparatus

(75) Inventors: Kenichi Kobayashi, Ebina-shi (JP); Kozo Tagawa, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/067,639

(22) Filed: Feb. 28, 2005

(30) Foreign Application Priority Data
Sep. 21, 2004 (JP) 2004-274207

(51) Int. Cl. G03G 15/00

(52) U.S. Cl. 399/384

(57) ABSTRACT

An electrophotographic printing apparatus comprises a paper-conveying device conveying a continuous paper sheet in a definite conveyance direction, a plurality of photoreceptors disposed downstream from the paper-conveying device at regular intervals in the conveyance direction of the continuous paper sheet, and one or more idler rollers that are disposed between the paper-conveying device and the most upstream photoreceptor and that rotate passively while contacting the continuous paper sheet wrapping around the rollers. The idler roller that the continuous paper sheet is in contact with at the largest wrap angle has a circumference that is equal to the whole or a fractional length of the interval between the axes of two adjacent photoreceptors.

### CROSS-REFERENCE TO RELATED APPLICATION

This application claims priority under USC 119 from Japanese Patent Application No. 2004-274207, the disclosures of which are incorporated by reference herein.

### BACKGROUND OF THE INVENTION

1. Field of the Invention

The present invention relates to a printing apparatus for recording an image on a continuous paper sheet, especially, an electro-photographic printing apparatus wherein misregistration between the toner images imposed on a continuous paper sheet can be prevented.

2. Description of the Related Art

Recently, electrophotographic image-forming apparatuses such as full-color printers or full-color copiers have become widely used. An electrophotographic image-forming apparatus typically has four photoreceptors on which yellow (herein after, referred to as “Y-color”), magenta (hereinafter, referred to as “M-color”), cyan (referred to as “C-color”), and black (hereinafter, referred to as “K-color”) toner images are formed, respectively. Toner images formed on each of the four photoreceptors are transferred to an intermediate transfer belt or a recording paper one after another in a superimposed manner to form a full color toner image.

In the above electrophotographic image-forming apparatus, when the conveyance velocity of the recording paper or the intermediate transfer belt changes when toner images are transferred from each photoreceptor, a misregistration arises between the toner images transferred onto the recording paper or the intermediate transfer belt.

When the above electrophotographic image-forming apparatus has an driving roller that is eccentric, the conveyance velocity of the recording paper conveyed by the driving drum changes periodically and thus, there is also a misregistration between the toner images transferred from each of the photoreceptors.

Misregistration between the toner images in each of Y-, M-, C-, and K-colors will drastically deteriorate the quality of a finally obtained image. Accordingly, it has been proposed to detect change in the conveyance velocities of the recording paper or the intermediate transfer belt and in accordance with the detected variation in velocity, to adjust the location wherein the toner images are transferred or to control the eccentricity of the driving roller so as to prevent a misregistration between each toner image (Japanese Patent Application Publication 07-031446, Japanese Patent Application Publication Laid-Open (JP-A) Nos. 2003-177591, 2003-066689, 02-075645, 09-175687, 2002-333744, 11-202576, 10-031331, and 2000-356936).

In the image-forming apparatus described in the above, the velocity of the recording paper is detected at a specific moment and transfer locations of the toner images are corrected. However, actually, the recording paper stretches or shrinks to some extent and thus, toner images sometimes cannot be superimposed accurately.

Additionally, in the above image-forming apparatus, not only the driving roller but an idler roller is often eccentric and thus, the toner images sometimes cannot be accurately superimposed only by controlling the eccentricity of the driving roller or by adjusting the transfer position of the toner images in accordance with the periodic variation of conveyance velocity caused by eccentricity of the driving roller.

### SUMMARY OF THE INVENTION

The present invention has been made in view of the above circumstances and provides a printing apparatus comprising a plurality of photoreceptors, by which toner images can be transferred to a continuous paper sheet without misregistration.

A first aspect for accomplishing the above purpose relates to a printing apparatus comprising: a paper-conveying device that conveys a continuous paper sheet in a definite conveyance direction, a plurality of photoreceptors disposed downstream from the paper-conveying device at regular intervals in the conveyance direction of the continuous paper sheet, one or more idler rollers that are disposed between the paper-conveying device and the photoreceptor and that rotate in contact with the continuous paper sheet; wherein the idler roller that the continuous paper sheet contacts at the largest wrap angle has a circumference that is equal to the whole or a fractional length of the intervals between the axes of the photoreceptors.

When an idler roller disposed upstream from the photoreceptors is eccentric, the path of the continuous paper sheet periodically changes even when the conveyance velocity of the continuous paper sheet is constant. Thus, the length of the conveyance path from the idler roller to the photoreceptor changes in the same period. The period is given by an equation of v/S=v/2πr wherein r, S and v are the radius, the circumference and the rotating velocity of the idler roller, respectively. Accordingly, the continuous paper sheet contacts each of the photoreceptors with a different timing, and thus, a misregistration between the toner images arises when each of the toner images is transferred from the photoreceptor to the continuous paper sheet.

When a plurality of idler drums are provided upstream from the photoreceptors, of the above idler rollers, the idler roller contacting the continuous paper sheet at a largest wrap angle changes the conveyance velocity of the continuous paper sheet to the largest extent.

In the printing apparatus of the first aspect, the circumference of the idler roller contacting the continuous paper sheet at the largest wrap angle is equal to the whole or a fractional length of the interval between the axes of two adjacent photoreceptors. Therefore, the toner images of each photoreceptor are enlarged or reduced by the same extent and thus, occurrence of misregistration in the toner images caused by the eccentricity of the idler roller can be prevented.

### BRIEF DESCRIPTION OF THE DRAWINGS

Embodiments of the present invention will be described in detail based on the following figures, wherein:

FIG. 1 is a side view showing the constitution of a printing apparatus of a first embodiment;

FIG. 2 is a perspective view showing the constitution of the printing apparatus of the first embodiment;

FIG. 3 illustrates a locational relationship between a conveyance direction-changing roller and photoreceptors of the printing apparatus of the first embodiment;

FIG. 4 is a sectional view showing the conveyance direction-changing roller and a transfer guide roller that are eccentric;

FIG. 5 is an explanatory diagram illustrating varying of a conveyance path of a continuous paper sheet p by the conveyance direction-changing roller that is eccentric;

FIG. 6 is an explanatory diagram illustrating varying of the conveyance velocity of the continuous paper sheet p by the conveyance direction-changing roller that is eccentric;

FIG. 7 is an explanatory diagram illustrating a relationship between variation of the conveyance velocity of the continuous paper sheet p and the location of the point where the continuous paper sheet contacts each of the photoreceptors when the conveyance direction-changing roller has a circumference that is equal to the intervals between the axes of the photoreceptors;

FIG. 8 is an explanatory diagram illustrating a relationship between variation of the conveyance velocity of the continuous paper sheet p and the location of the point where the continuous paper sheet contacts each of the photoreceptors when the conveyance direction-changing roller has a circumference that is half of the intervals between the axes of the photoreceptors;

FIG. 9 is a side view showing the constitution of a printing apparatus of a second embodiment;

FIG. 10 is a perspective view showing the constitution of the printing apparatus of the second embodiment;

FIG. 11 is a side view showing the constitution of the printing apparatus of a third embodiment;

FIG. 12 is a perspective view showing the constitution of the printing apparatus of the third embodiment;

FIG. 13 is an explanatory diagram illustrating a locational relationship between sections A to D of the continuous paper sheet p and a Y-color image-forming section, a M-color image-forming section, a C-color image-forming section, and a K-color image-forming section of the printing apparatus of the third embodiment;

FIG. 14 is a graph illustrating a relative comparison between stress applied to the continuous paper sheet p by each of the Y-color image-forming section, the M-color image-forming section, the C-color image-forming section, and the K-color image-forming section.

### DETAILED DESCRIPTION OF THE INVENTION

In the printing apparatus of the first embodiment, the idler roller contacting the continuous paper sheet at the largest wrap angle is preferably a conveyance direction-changing roller that changes the conveyance direction of the continuous paper sheet between the paper-conveying device and the photoreceptors.

The conveyance direction-changing roller generally contacts the continuous paper sheet at a large wrap angle when only a short distance is left between the paper-conveying device and a most upstream photoreceptor and the conveyance path of the continuous paper sheet is largely changed in direction between the paper-conveying device and the photoreceptor.

Accordingly, when the circumference of the conveyance direction-changing roller is a length that is equal to the whole or a fractional length of intervals between the axes of the photoreceptors, the misregistration in the toner images can be prevented.

Another preferable example of the printing apparatus of the first aspect includes a printer having an intermediate roller that is disposed between the photoreceptors, contacts the continuous paper sheet and rotates passively, and has a circumference equal to the whole or a fractional length of each interval between the axes of the photoreceptors.

When the intermediate roller located between two adjacent photoreceptors is eccentric, the continuous paper sheet is pulled periodically by the intermediate roller rotating passively and thus, the conveyance velocity changes periodically. Accordingly, at downstream photoreceptors, the timing for contacting the continuous paper sheet at a specific point thereon differs and thus, there arises misregistration between the toner images transferred from the photoreceptors to the continuous paper sheet.

However, when the circumference of the intermediate roller is equal to the whole or a fractional length of the each interval between the axes of the photosensitive rollers, toner images are stretched or reduced to the same extent at the photosensitive rollers that are upstream and downstream from the intermediate roller. Consequently, misregistration in the toner images transferred to the continuous paper sheet caused by eccentricity of the intermediate roller can be prevented.

A second aspect of the present invention relates to an electrophotographic printing apparatus comprising a paper-conveying device conveying a continuous paper sheet in a definite conveyance direction, a plurality of photoreceptors disposed downstream from the paper-conveying device at regular intervals in the conveyance direction of the continuous paper sheet, and a conveyance guide member provided between the paper-conveying device and the most upstream photoreceptor and contacting the continuous paper sheet so that the continuous paper sheet is guided along a predetermined conveyance path. The side of the conveyance guide member contacting the continuous paper sheet is formed of a low-friction material wherein the friction coefficient between the low-friction material and the continuous paper sheet is lower than the friction coefficient between a driving roller incorporated by the conveying device and the continuous paper sheet.

In the printing apparatus of the second aspect, the continuous paper sheet is conveyed on a definite path along the conveyance guide member since the conveyance guide member is provided between the paper-conveying device and the photoreceptor.

Accordingly, only by controlling the conveyance velocity of the continuous paper sheet to be a constant velocity at the paper-conveying device, there is no variation between the conveyance velocity at the paper-conveying device and the conveyance velocity at the photoreceptors. Consequently, misregistration in the toner images transferred to the continuous paper sheet caused by a change in the conveyance velocity can be effectively prevented.

A preferable example of the printing apparatus of the second aspect includes a printer comprising an intermediate guide member guiding the continuous paper sheet along a specific conveyance path in contact with the continuous paper sheet. The side of the intermediate guide member contacting the continuous paper sheet is formed of a low-friction material having a friction coefficient lower than the friction coefficient between the driving roller and the continuous paper sheet.

The continuous paper sheet is conveyed at a constant conveyance velocity between the photoreceptors. Thus, only by controlling the conveyance velocity of the continuous paper sheet to be at a constant velocity at the paper-conveying device, toner images can be superimposed on the continuous paper sheet without any misregistration.

A third aspect of the present invention relates to an electrophotographic printing apparatus comprising a paper-conveying device conveying a continuous paper sheet in a definite conveyance direction; a plurality of image-forming sections that form toner images and are disposed downstream from the paper-conveying device with respect to the conveyance direction of the continuous paper sheet; an elongation-detecting device detecting elongation of the continuous paper sheet at the most upstream and the most downstream color image-forming sections; and an image position-controlling device controlling the image-forming sections with reference to the elongation of the continuous paper sheet detected by the elongation-detecting device so that the toner images that can be superimposed without misregistration are formed at each of the image-forming sections.

In a typical electrophotographic image-forming apparatus, an attraction is generated between a continuous paper sheet and photoreceptors when the continuous paper sheet contacts an image-forming section. Thus, stress is accumulated at sections of the continuous paper sheet contacting the photoreceptors, and consequently, the continuous paper sheet elongates. Additionally, at each of the sections, the continuous paper sheet elongates at different extents, and thus, there is a difference in the conveyance velocity between different sections of the continuous paper sheet. Consequently, there is a variation in the starting point for each toner image. Not only an upstream photoreceptor but a downstream photoreceptor creates a stress in a stretching direction of the continuous paper sheet. Accordingly, the continuous paper sheet has a longer elongate at a downstream section and a larger stress is applied to an upstream section.

Additionally, the attraction between the photoreceptors and the continuous paper sheet depends on spannage that is an areal proportion of the surface of each of the photoreceptors spanned by a toner image. Therefore, it is very difficult to predict the intensity of stress caused by the attraction for each photoreceptor.

In the printing apparatus of the third aspect, elongation of the continuous paper sheet contacting the photoreceptors is detected by the elongation-detecting device at least at the most upstream color image-forming section and the most downstream color image-forming section. Thus, misregistration between toner images can be prevented regardless of the intensity of stress applied to the continuous paper sheet.

In the above printing apparatus, elongation of the continuous paper sheet is preferably detected at each of the image-forming sections. However, when elongation of the continuous paper sheet is detected at the most upstream color image-forming section and the most downstream color image-forming section, elongation of the continuous paper sheet at two intermediate image-forming sections can be calculated from a difference in elongation of the continuous paper sheet between two adjacent image-forming sections or from the elongation at the most upstream color image-forming section and the most downstream color image-forming section.

In the above printing apparatus, elongation of the continuous paper sheet is detected at each image-forming section and the starting point for toner images formed on the photoreceptors is adjusted. Therefore, the location of each toner image can be further accurately controlled.

The printing apparatus of the third aspect preferably comprises a conveyance velocity-detecting device. The elongation-detecting device can obtain the elongation of the continuous paper sheet from a conveyance velocity detected by the conveyance velocity-detecting device.

The above printing apparatus is an example of the printing apparatus of the third aspect wherein elongation of the continuous paper sheet is calculated from the conveyance velocity of the continuous paper sheet detected by the conveyance velocity-detecting device. The printing apparatus of the third aspect includes a printing apparatus wherein elongation of the continuous paper sheet is calculated from a tension of the continuous paper sheet.

In the printing apparatus of the third aspect, the image position-controlling device can adjust the starting position at which toner image-forming is started by controlling the rotating velocity of the photoreceptors possessed by the image-forming sections.

When each photoreceptor is driven independently, by controlling the revolution of the photoreceptors in accordance with elongation of the continuous paper sheet, toner images can be transferred to the continuous paper sheet without misregistration. Elongation of the continuous paper sheet can be detected from a difference in the conveyance velocity between upsream and downsream of the photoreceptors.

In the printing apparatus of the third aspect, the image position-controlling device also preferably controls position of the toner images by controlling toner image-forming timing.

In the above printing apparatus, misregistration between the toner images can be reduced to half compared with a printing apparatus not controlling the timing for image-forming in the image-forming sections. In addition, simpler software can be used for image-formation control at each photoreceptor.

Accordingly, the printing apparatus can be used when elongation of the continuous paper sheet is relatively smaller, e.g., when the continuous paper sheet has a large thickness or a high strength and when the spannage is small at each of the photoreceptors.

The printing apparatus of the third aspect also includes a printing apparatus wherein the image position-controlling device controls each of the image-forming sections so as to form a toner image in a higher/lower magnification when the elongation-detecting device has detected a larger/smaller elongation of the continuous paper sheet.

In the above printing apparatus, the misregistration between superimposed toner images is cancelled by controlling magnification of the toner images at each of the image-forming sections. Consequently, it is not necessary for each photoreceptor to be driven independently and only the most upstream photoreceptor needs to be driven and the rest of the photoreceptors can rotate passively.

### 1. A FIRST EMBODIMENT

A continuous paper sheet printer that is an example of the printing apparatus of the present invention is described in the following.

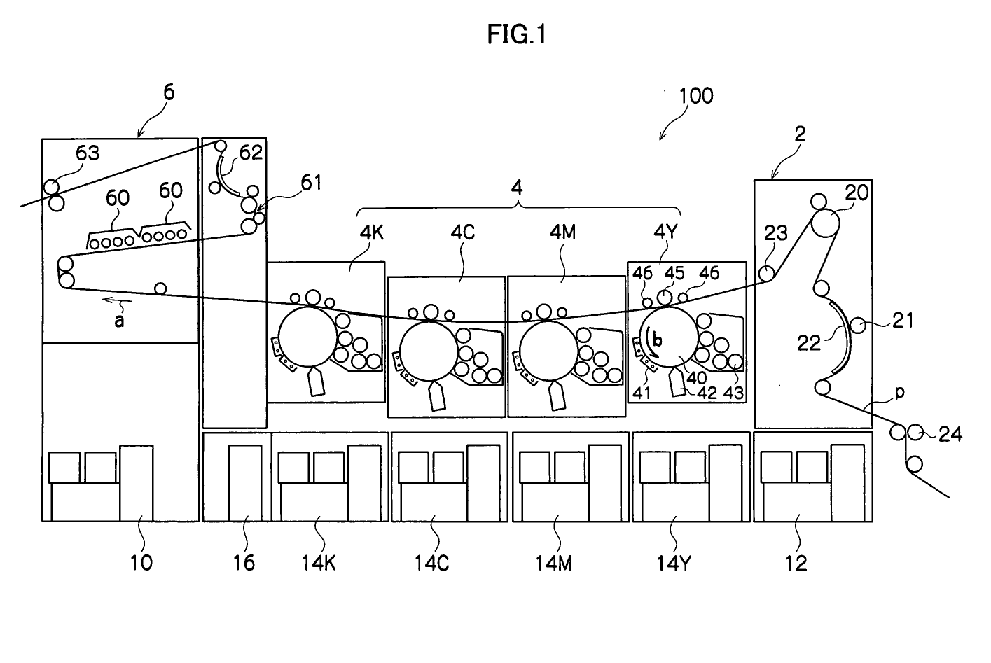

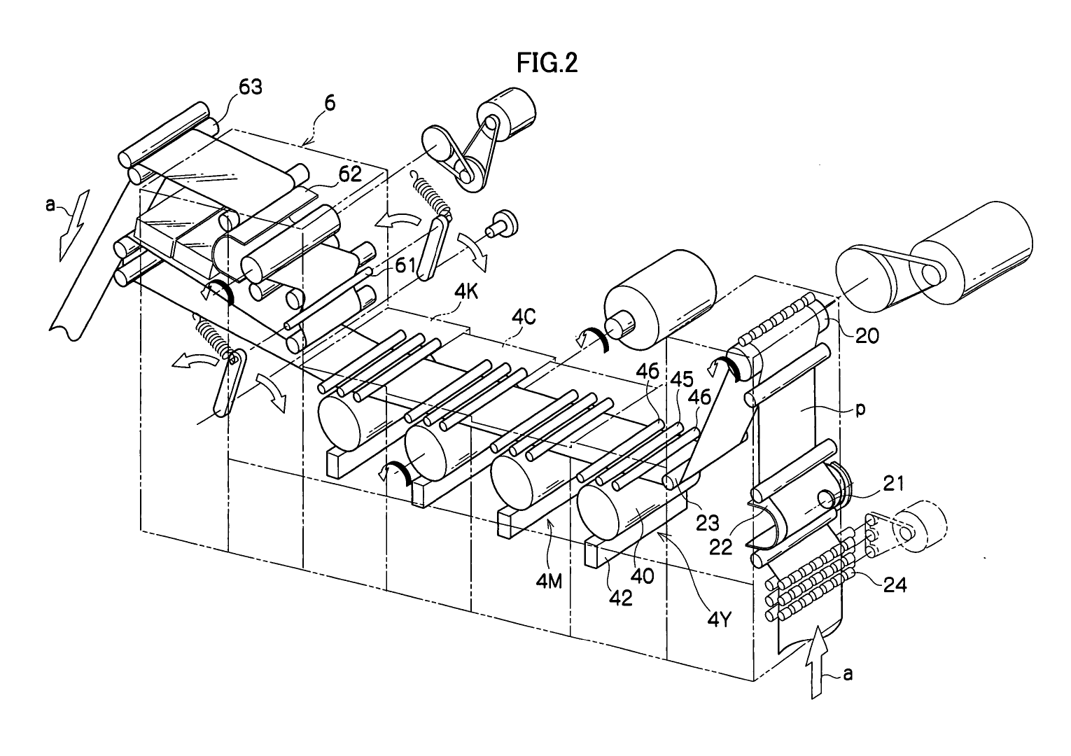

As shown in FIGS. 1 and 2, a continuous paper sheet printer 100 of the first embodiment is an electrophotographic continuous paper sheet printer. The continuous paper sheet printer 100 includes a paper-conveying section 2 conveying a continuous paper sheet p, an image-forming section 4 forming a full color toner image and transferring the full color toner image to the continuous paper sheet p, and an image-fixing section 6 fixing the toner image transferred to the continuous paper sheet p. The paper-conveying section 2, the image-forming section 4, and the image-fixing section 6 are provided from upstream to downstream with respect to the conveyance direction ‘a’ of the continuous paper sheet p.

The paper-conveying section 2 includes a tensioning roller set 24, aligning roller 21, main driving rollers 20, and a conveyance direction-changing roller 23, all of which are disposed from upstream to downstream with respect to the conveyance direction ‘a’.

The main driving rollers 20 have the function of conveying the continuous paper sheet p at a predetermined conveyance velocity in the conveyance direction ‘a’ with nipping the continuous paper sheet at a predetermined pressure.

The aligning roller 21 aligns the continuous paper sheet p at upstream from the main driving roller 20 in cooperation with a guide member 22 having a partial cylindrical surface so that the continuous paper sheet p is conveyed along a predetermined conveyance path.

The tensioning roller set 24 has, for example, three pairs of rollers and rotates in the same direction as the main driving roller 20 but at a lower velocity so as to provide a tension to the continuous paper sheet p.

The conveyance direction-changing roller 23 is an idler roller rotating with the continuous paper sheet p wrapping around it so as to change the conveyance direction of the continuous paper sheet p conveyed by the main driving roller 20 in a direction toward the image-forming section 4. The conveyance direction-changing roller 23 has a circumference that is equal to each interval between photoreceptors 40 in the image-forming section 4 or equal to a fraction thereof, for example, a half-length of the intervals.

The image-forming section 4 includes from upstream to downstream a Y-color image-forming section 4Y forming a yellow (hereinafter, referred to as “Y-color”) toner image, a M-color image-forming section 4M forming a magenta (hereinafter, referred to as “M-color”) toner image, a C-color image-forming section 4C forming a cyan (hereinafter, referred to as “C-color”) toner image, and a K-color image-forming section 4K forming a black (hereinafter, referred to as “K-color”) toner image.

The Y-color image-forming section 4Y, the M-color image-forming section 4M, the C-color image-forming section 4C, and the K-color image-forming section 4K respectively has the photoreceptor 40 rotating in a direction shown by the arrow b, a corona-charging device 41 that charges the surface of the photoreceptor 40, a laser-exposing device 42 disposed downstream from the corona charging device 41 with respect to the rotating direction b, a developing section 43 disposed downstream from the laser-exposing device 42 with respect to the rotating direction b, a transfer roller 45 disposed so as to face the photoreceptor 40 with the conveyance path of the continuous paper sheet p therebetween, and a pair of transfer guide rollers 46 located upstream and downstream from the transfer roller 45.

An electrostatic latent image is formed on the surface of the photoreceptor 40. The corona-charging device 41 charges the surface of the photoreceptor 40 at a specific voltage. The laser-exposing device 42 exposes, image-wise, the photoreceptor 40 that has been charged by the corona-charging device 41. The developing section 43 develops the latent image formed on the surface of the photoreceptor 40 by the laser exposing device 42 with a developing agent containing a magnetic carrier and a toner to form a Y-, M-, C-, or K-color toner image. The transfer roller 45 and the transfer guide rollers 46 press the continuous paper sheet p onto the photoreceptor 40 so that the toner image formed on the surface of the photoreceptor 40 is transferred to the continuous paper sheet p.

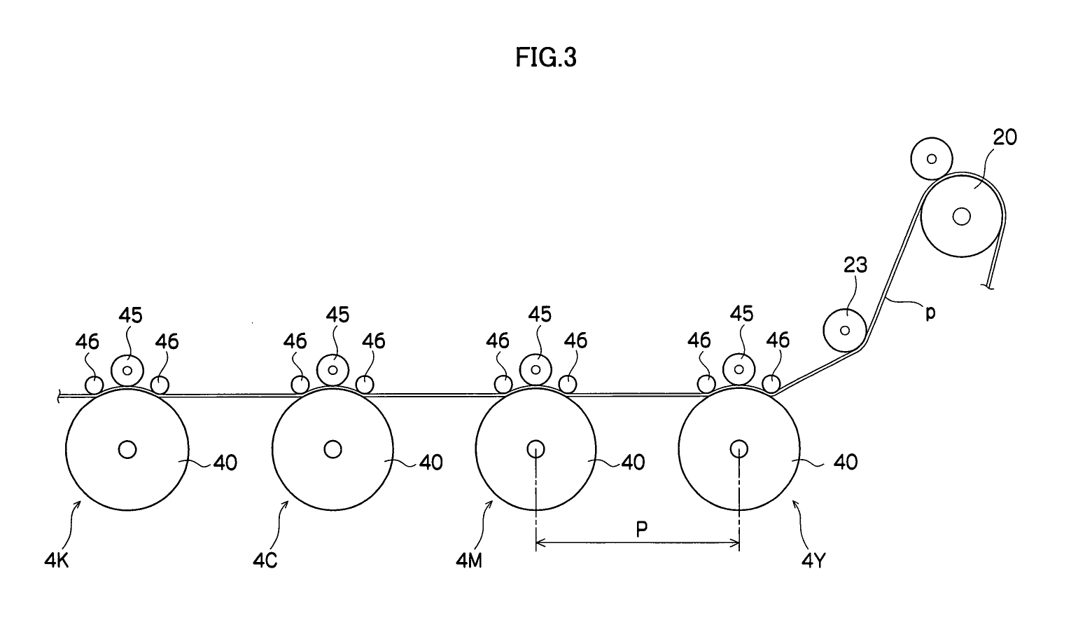

As shown in FIG. 3, each of the photoreceptors 40 of the Y-color image-forming section 4Y, the M-color image-forming section 4M, the C-color image-forming section 4C, and the K-color image-forming section 4K, has the same radius and disposed at the regular interval. In each of the Y-color image-forming section 4Y, the M-color image-forming section 4M, the C-color image-forming section 4C, and the K-color image-forming section 4K, the transfer guide rollers 46 are idler rollers rotating passively with the continuous paper sheet wrapping around them and have a circumference that is equal to a fraction, for example, a quarter, of the interval P of the photoreceptors 40.

The image-fixing section 6 includes a flash fixing device 60 for flash fusing the toner image transferred onto the continuous paper sheet p, a tension-providing device 61 tensioning the continuous paper sheet p at a section downstream from the flash fixing device 60, an aligning device 62 adjusting the conveyance path of the continuous paper sheet p in the width direction thereof at a section downstream from the tension-providing device 61, and a tensioning roller pair 63 having a pair of rollers nipping the continuous paper sheet p and rotating at a rotating velocity faster than the conveyance velocity of the continuous paper sheet p at the exit of the continuous paper sheet printer 100 to tension the continuous paper sheet.

The continuous paper sheet printer 100 has a general control computer 10 controlling the continuous paper sheet printer 100 totally, a paper conveyance control computer 12 controlling the paper-conveying section 2, a Y-color image formation control computer 14Y controlling the Y-color image-forming section 4Y, a M-color image formation control computer 14M controlling the M-color image-forming section 4M, C-color image formation control computer 14C controlling the C-color image-forming section 4C, K-color image formation control computer 14K controlling the K-color image-forming section 4K, and an image-fixing control computer 16 controlling the image-fixing section 6.

The general control computer 10 controls the paper conveyance computer 12, Y-color image formation control computer 14Y, M-color image formation control computer 14M, C-color image formation control computer 14C, K-color image formation control computer 14K, and image-fixing control computer 16.

The function of the continuous paper sheet printer 100 is described below.

When image data are input to the general control computer 10, the general control computer 10 controls the paper-conveying section 2 through the paper-conveyance computer 12 and controls the tensioning roller pair 63 through the image-fixing control computer 16 to convey the continuous paper sheet p in the conveyance direction ‘a’ at a predetermined conveyance velocity while providing a constant tension.

Each of the Y-color image-forming sections from the 4Y-color image-forming section 4Y to the K-color image-forming section 4K, photoreceptor 40 is controlled so as to rotate at a rotating velocity somewhat faster, e.g., 1 to 3% faster, than the conveyance velocity of the continuous paper sheet p by the general control computer 10 through the Y-color image formation control computer 14Y, M-color image formation control computer 14M, C-color image formation control computer 14C, or K-color image formation control computer 14K.

When the continuous paper sheet printer 100 is started, the general control computer 10 separates the image data input thereto into image data corresponding Y-color image, M-color image, C-color image, and K-color image, respectively, and then input the image data of each color into the Y-color image formation control computer 14Y, M-color image formation control computer 14M, C-color image formation control computer 14C, and K-color image formation control computer 14K.

When image data are input to the Y-color image formation control computer 14Y, M-color image formation control computer 14M, C-color image formation control computer 14C, and K-color image formation control computer 14K, respectively, then in each of the Y-color image-forming section 4Y, the M-color image-forming section 4M, the C-color image-forming section 4C, and the K-color image-forming section 4K, the photoreceptor 40 is charged by the corona charging device 41 and exposed image-wise by the laser exposing device 42 to form a latent image thereon. Then, at the developing device 43, toner is applied to the latent image on the photoreceptor 40 to form a toner image. The toner image formed on the photoreceptor 40 is transferred to the continuous paper sheet p by the transfer roller 45 and the transfer guide rollers 46. The continuous paper sheet p passes in order through the Y-color image-forming section 4Y, the M-color image-forming section 4M, the C-color image-forming section 4C, and then, the K-color image-forming section 4K. Thus, toner images formed at the Y-color image-forming section 4Y, the M-color image-forming section 4M, the C-color image-forming section 4C, and the K-color image-forming section 4K are superimposed in the order of Y-color toner image, M-color toner image, C-color toner image, and K-color toner image to form a full color toner image.

After a full color toner image is transferred at the image-forming section 4, the continuous paper sheet p is introduced into the image-fixing section 6 and fixed by the flash fixing device 60.

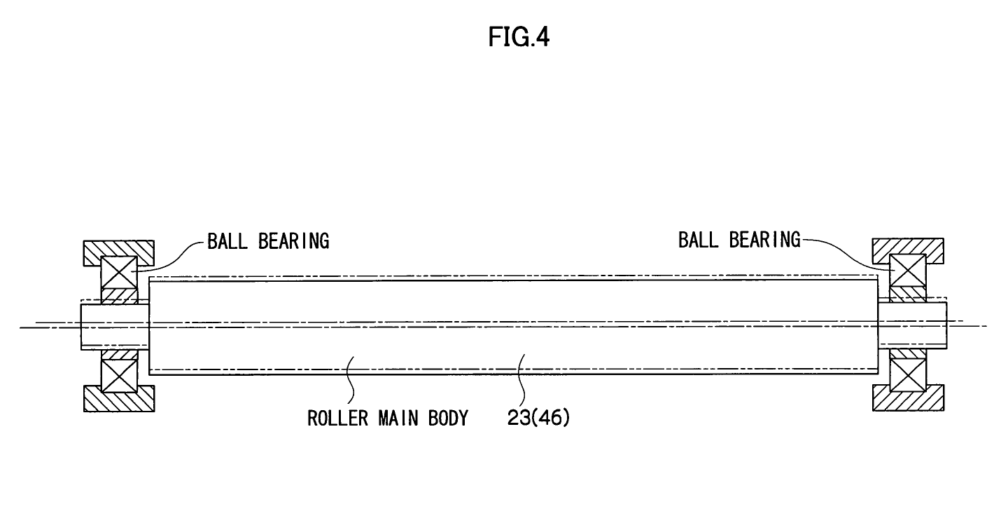

As shown in FIG. 4, the conveyance direction-changing roller 23 and/or the transfer guide rollers 46 are sometimes eccentric because of error thereof when being worked or fitted. When the conveyance direction-changing roller 23 and the transfer guide rollers 46 are eccentric, the conveyance direction-changing roller 23 and the transfer guide rollers 46 rotate passively and change the conveyance path of the continuous paper sheet p periodically.

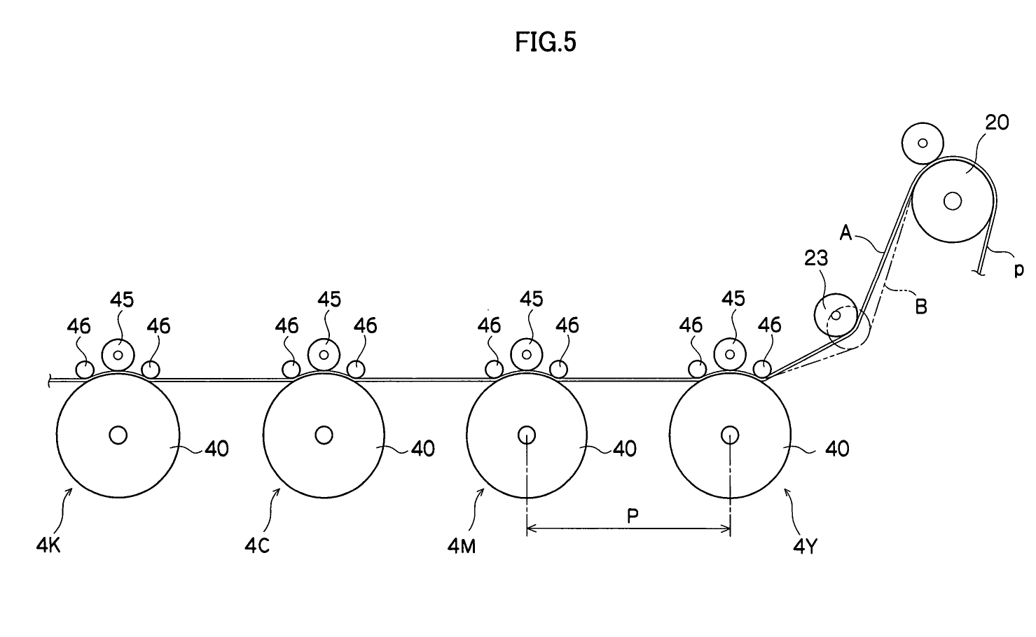

When the conveyance direction-changing roller 23 is eccentric, as shown in FIG. 5, the conveyance path of the continuous paper sheet p changes between a path A shown in a full line and a path B shown in a double dotted line. Consequently, even when the continuous paper sheet p is conveyed at a constant conveyance velocity by the main driving roller 20, the direction of a vector showing the conveyance direction of the continuous paper sheet changes periodically, and the path length from the main driving roller 20 to the photoreceptor of the Y-color image-forming section 4Y, being the most upstream color image-forming section, changes. Accordingly, when travelling a different conveyance path, the continuous paper sheet p passes the photoreceptor with a different timing and thus, there occurs misregistration where a Y-color image starts.

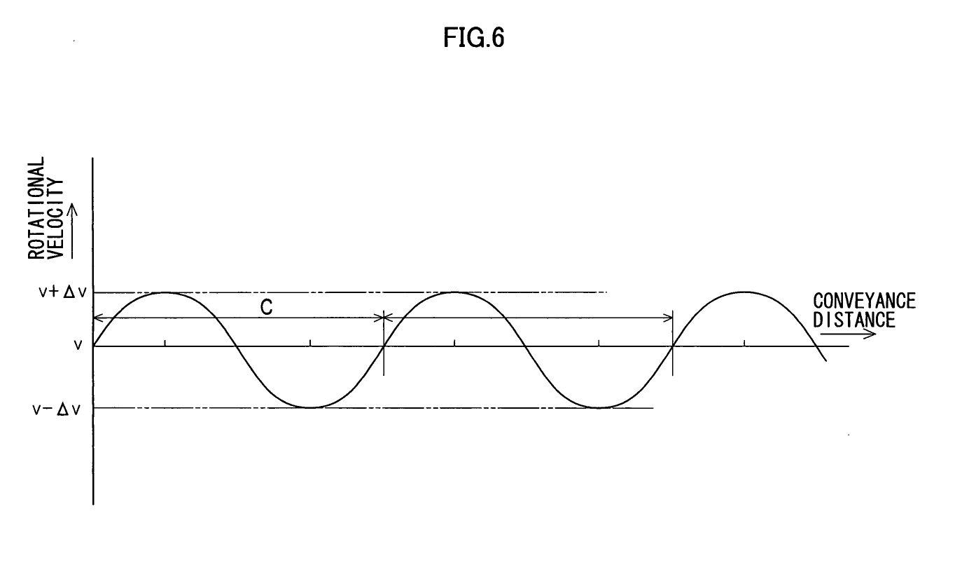

When the conveyance path of the continuous paper sheet p changes from the path A to the path B, the continuous paper sheet p is pulled towards the main driving roller 20. Accordingly, the continuous paper sheet p passes at a lower velocity when passing at the photoreceptor 40 of the Y-color image-forming section 4Y. On the contrary, when the conveyance path of the continuous paper sheet p changes from the path B to the path A, the continuous paper sheet p is pulled by the photoreceptor 40 of the Y-color image-forming section 4Y and thus, the continuous paper sheet p passes at a higher conveyance velocity at the photoreceptor 40. Consequently, as shown in FIG. 6, the conveyance velocity of the continuous paper sheet p contacting with the photosensitive roller 40 changes sinusoidally in a range from V−□V to V+□V and in a period given by c=2πr (r is the radius of the conveyance direction-changing roller 23).

However, as described previously, in the continuous paper sheet printer 100, the conveyance direction-changing roller 23 has a circumference equal to the interval P of the photoreceptors 40 or a length equal to a fraction, e.g., a half, of the interval P.

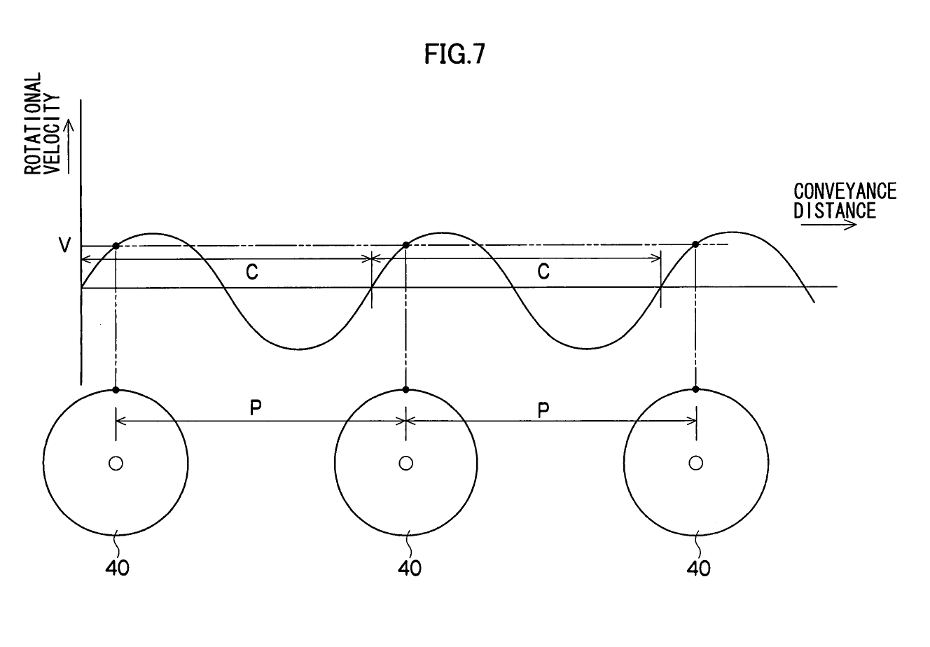

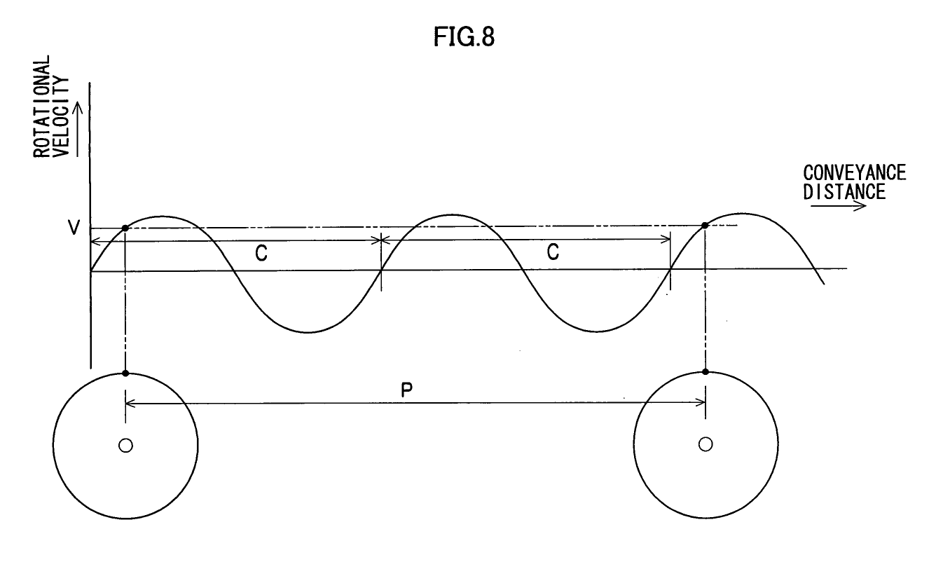

Accordingly, as shown in FIG. 7 (the conveyance direction-changing roller 23 having a circumference equal to the interval P.) or in FIG. 8 (the conveyance direction-changing roller 23 having a circumference equal to a half of the interval P). Thus, when the continuous paper sheet p passes each of the Y-color image-forming section 4Y, the M-color image-forming section 4M, the C-color image-forming section 4C, and the K-color image-forming section 4K, the continuous paper sheet p contacts the photoreceptors 40 at the same timing. Therefore, in each of the Y-color image-forming section 4Y, the M-color image-forming section 4M, the C-color image-forming section 4C, and the K-color image-forming section 4K, toner images are formed with the same amount of variation. Consequently, a Y-color toner image, an M-color toner image, a C-color toner image, and a K-color toner image are superimposed on the continuous paper sheet p without any misregistration.

The transfer guide rollers 46 have a circumference equal to a fraction, e.g., a quarter, of the interval P of the photosensitive rollers 40 and thus, when the continuous paper sheet p passes each of the Y-color image-forming section 4Y, the M-color image-forming section 4M, the C-color image-forming section 4C, and the K-color image-forming section 4K, the continuous paper sheet p contacts the photoreceptors 40 at the same timing. Consequently, even though the transfer guide rollers 46 are eccentric, Y-color, M-color, C-color, and K-color toner images can be transferred to the continuous paper sheet p without any misregistration.

The continuous paper sheet printer 100 of the first embodiment can effectively accomplish the principal purpose of the present invention of providing a tandem-type printer using an electrophotographic printer wherein misregistration among toner images can be limited to an extremely small extent.

Although it is regarded as being almost impossible to make 100 or more prints in one minute with a high-speed color printer employing a xerographic (trade name) process, with the continuous paper sheet printer 100 of the first embodiment, 100 or more prints can be easily made since a continuous paper sheet is used as a recording medium and toner images transferred to the continuous paper sheet are fixed by flash-fusing.

Although misregistration in toner images could be reduced by conveying the continuous paper sheet p along a straight path from the main driving roller 20 to the Y-color image-forming section 4Y, structuring a printer having a straight path from the driving roller 20 to the Y-color image-forming section 4Y is almost impossible.

In the continuous paper sheet printer 100 of the first embodiment, the conveyance path of the continuous paper sheet p is bent by wrapping the continuous paper sheet p around the conveyance direction changing roller 23 at a large wrapping angle. Consequently, the continuous paper sheet printer 100 can be configured without major difficulty while full color images having a higher quality can be printed in a higher quantity.

### 2. A SECOND EMBODIMENT

A continuous paper sheet printer that is another example of the printing apparatus of the present invention is described in the following.

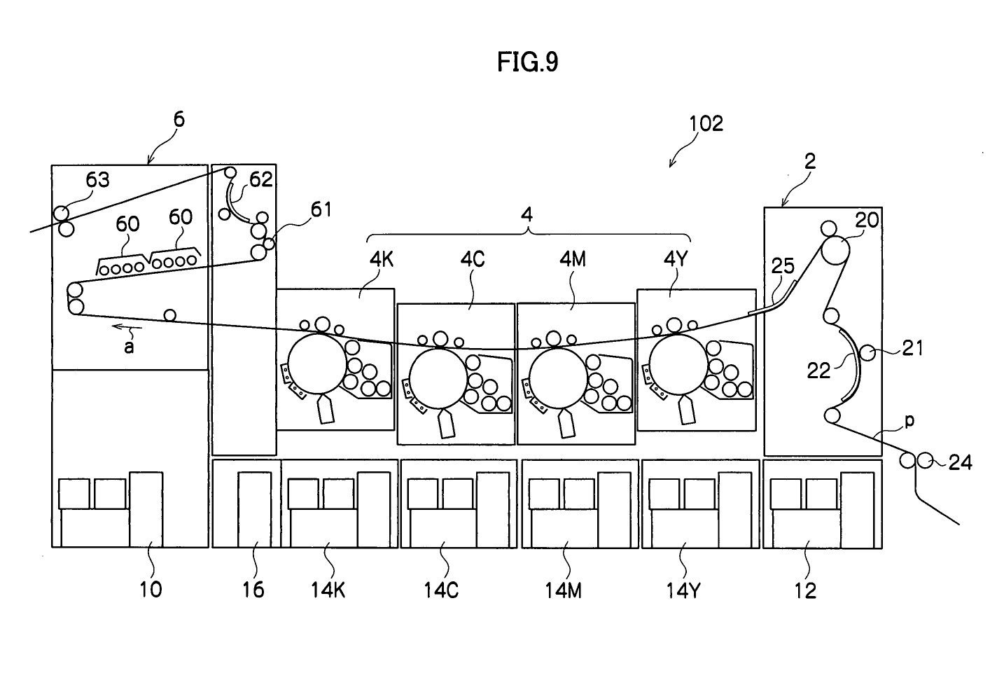

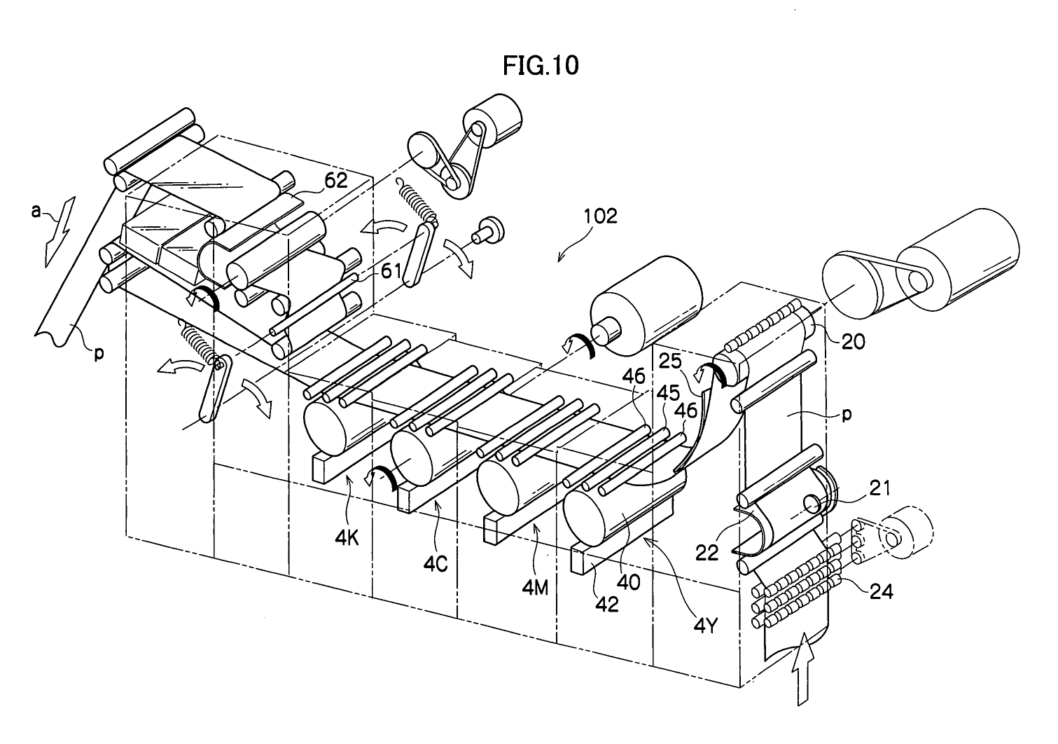

As shown in FIGS. 9 and 10, a continuous paper sheet printer 102 of the second embodiment is also an electrophotographic printer having a conveyance guide plate 25 corresponding to the conveyance guide member between a main driving roller 20 and a Y-color image-forming section 40Y in place of the conveyance direction-changing roller 23 in the continuous paper sheet printer 100 of the first embodiment.

The conveyance guide plate 25 is a member having a partial cylindrical surface protruding toward the conveyance path of a continuous paper sheet p. The conveyance guide plate 25 is fixed in the continuous paper sheet printer 102. The continuous paper sheet p is in contact with the protruding side of the conveyance guide plate 25 and is guided along a predetermined conveyance path. The side of the conveyance guide plate 25 with which the continuous paper sheet p is in contact is formed of a low-friction material such as an ultrahigh molecular weight polyethylene or a fluoroplastic such as polytetrafluoroethylene.

The continuous paper sheet printer 102 is started with the same procedure as that of the continuous paper sheet printer 100 of the first embodiment. The Y-color image-forming section 4Y, the M-color image-forming section 4M, the C-color image-forming section 4C, and the K-color image-forming section are also controlled so that each photoreceptor 40 rotates at a circumferential velocity 1 to 3% faster than the conveyance velocity of the continuous paper sheet p.

The continuous paper sheet p is conveyed while being pressed toward the protruding side of the conveyance guide plate 25 so as to be tightened and thus, the continuous paper sheet p passes a predetermined path between the main driving roller 20 and the Y-color image-forming section 4Y.

Consequently, misregistration between toner images superimposed on the continuous paper sheet arising because of a periodical change in the conveyance path between the main driving roller 20 and the Y-color image-forming section 4Y can be prevented.

The continuous paper sheet printer 102 of the second embodiment has the same advantages as those of the continuous paper sheet printer 100 of the first embodiment. Further, misregistration between superimposed toner images can be limited to an extremely small extent even when the conveyance path of the continuous paper sheet p bends only slightly between the main driving roller 20 and the Y-color image-forming section 4Y.

### 3. A THIRD EMBODIMENT

A continuous paper sheet printer further exemplifying the printing apparatus of the present invention is described in the following.

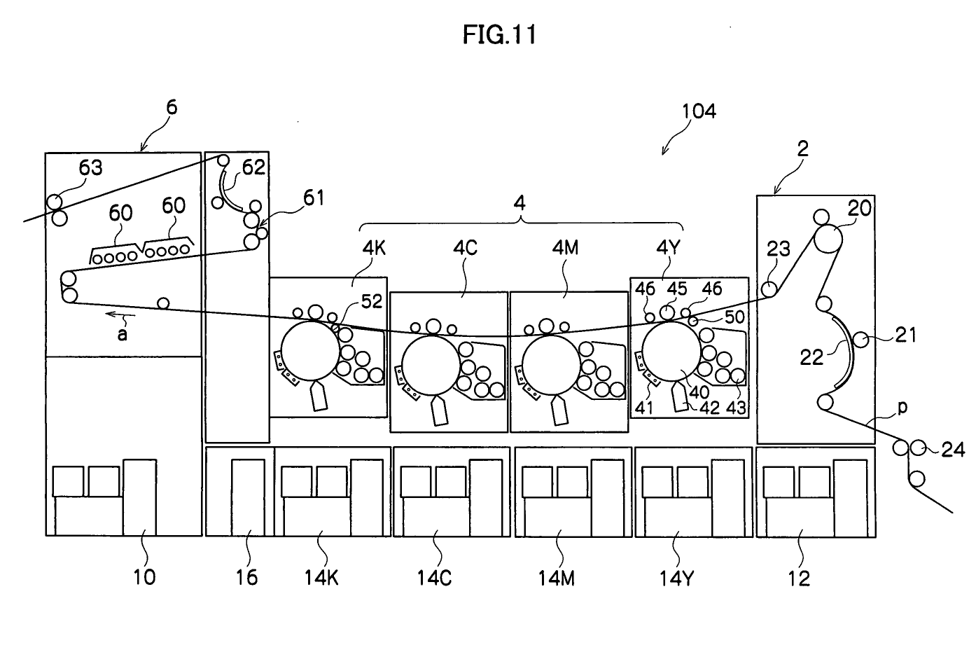

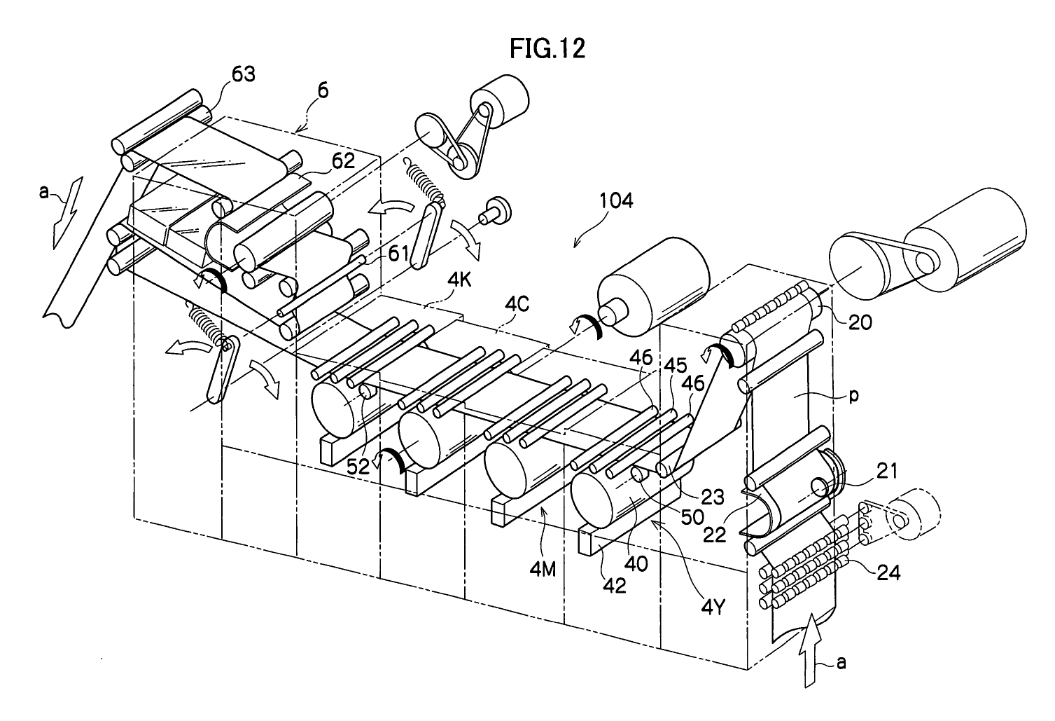

As shown in FIGS. 11 and 12, the continuous paper sheet printer of the third embodiment 104 is an electrophotographic printer having the same configuration as that of the continuous paper sheet printer 100 of the first embodiment except that a velocity-detecting roller 50 is provided at the Y-color image-forming section 4Y and that a velocity-detecting roller 52 is provided at the K-color image-forming section 4K. The Y-color image-forming section 4Y, the M-color image-forming section 4M, the C-color image-forming section 4C, and the K-color image-forming section 4K correspond to the image-forming section of the printing apparatus relating to the present invention. The Y-color image-forming section 4Y and the K-color image-forming section 4K correspond to the most upstream color image-forming section and the most downstream color image-forming section, respectively.

In the Y-color image-forming section 4Y, the M-color image-forming section 4M, the C-color image-forming section 4C, and the K-color image-forming section 4K, the rotating velocity of the photoreceptor 40 can be set at a rotating velocity 1 to 3% faster than a let-off velocity of the continuous paper sheet p when let off from the main-driving roller 20 so as to tighten the continuous paper sheet p and direct the stress applied to the continuous paper sheet p in the downstream direction. Additionally, by setting the rotating velocity of the photoreceptor to be higher the more upstream an color image-forming section is, the direction of stress can be directed with more certainty.

Both the velocity-detecting rollers 50 and 52 are rollers in contact with the continuous paper sheet p and rotating passively, to which rotary encoders are connected. The conveyance velocity of the continuous paper sheet p at the Y-color image-forming section 4Y and at the K-color image-forming section 4K are obtained from the circumferences of the velocity-detecting rollers 50 and 52 and the rotation velocities thereof detected by the rotary encoders. Then, from the conveyance velocity v1 detected by the velocity-detecting roller 50 and the conveyance velocity v4 detected by the velocity-detecting roller 52, the conveyance velocity v2 at the M-color image-forming section 4M and the conveyance velocity v3 at the C-color image-forming section 4K are obtained.

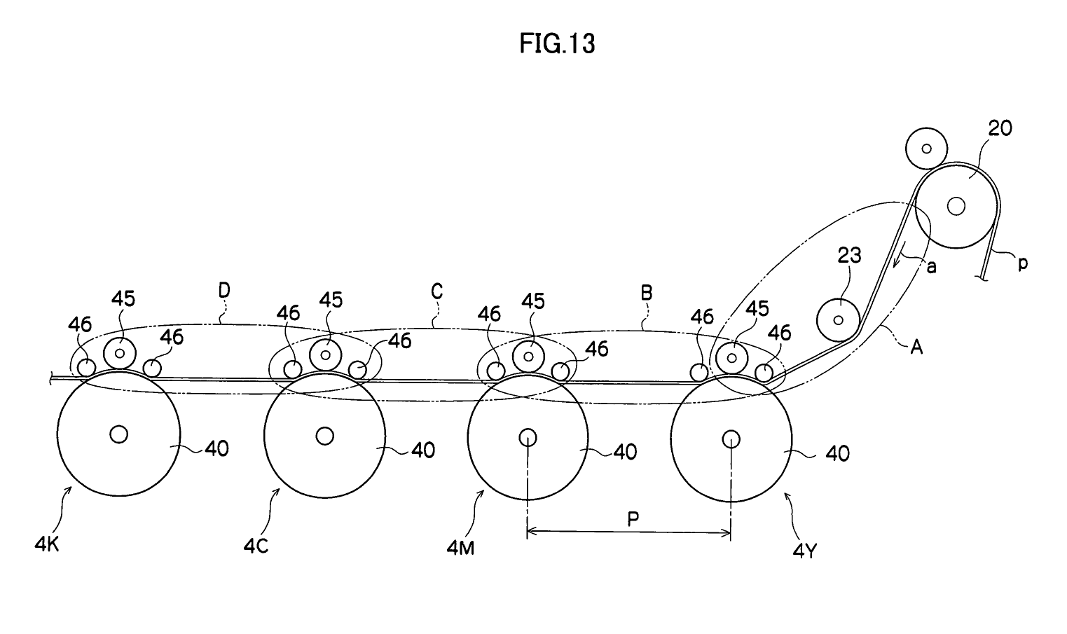

As shown in FIG. 13, in a section D of the continuous paper sheet p spanning from the C-color image-forming section 4C to the K-color image-forming section 4K, a stress is applied to the continuous paper sheet p by the photoreceptor 40 of the most downstream color image-forming section, K-color image-forming section 4K. In a section C of the continuous paper sheet p spanning from the M-color image-forming section 4M to the C-color image-forming section 4C, a stress from the photoreceptor 40 of the C-color image-forming section 4C is added to the stress from the K-color image-forming section 4K. In a section B of the continuous paper sheet p spanning from the Y-color image-forming section 4Y to the M-color image-forming section 4M, a stress is applied to the continuous paper sheet by the three photosensitive rollers 40 of from the K-color image-forming section 4K to the M-color image-forming section 4M. In a section A of the continuous paper sheet p spanning from the Y-color image-forming section to the main driving roller 20, a stress is applied to the continuous paper sheet by the four photosensitive rollers 40 of from the K-color image-forming section 4K to the Y-color image-forming section 4Y.

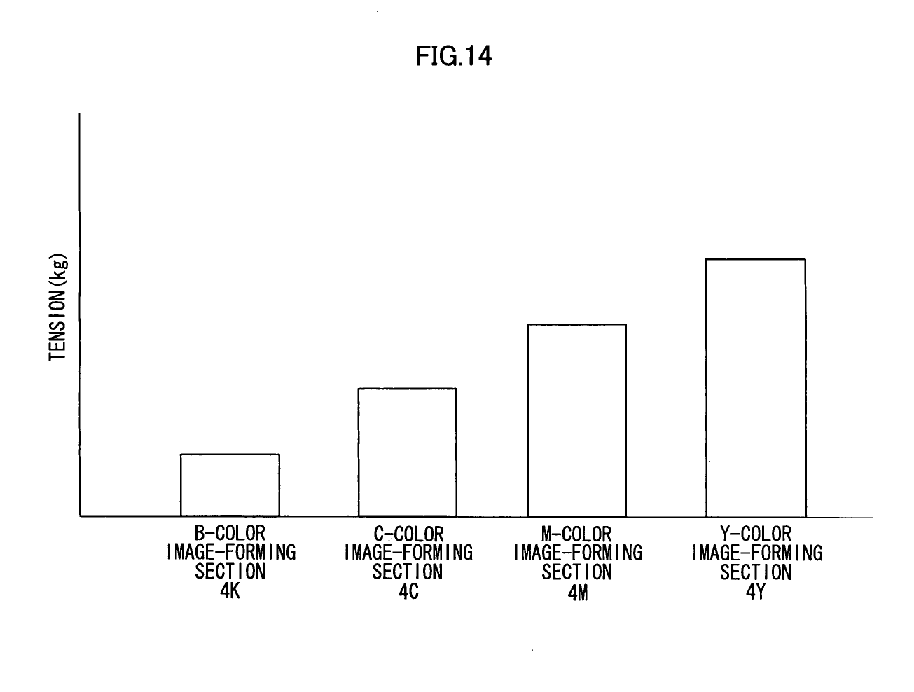

Accordingly, as shown in FIG. 14, tension applied at an image-forming section to the continuous paper sheet increases linearly from a downstream color image-forming section to an upstream color image-forming section and thus, elongation of the continuous paper sheet p at an image-forming section increases linearly from a downstream color image-forming section to an upstream color image-forming section. The more the continuous paper sheet elongates, the lower the conveyance velocities v1 to v4 are. Thus, the conveyance velocity v2 and v3 can be obtained by the following equations:
v2=v1+(v4−v1)/3
v3=v1+2(v4−v1)/3

The conveyance velocities v1 to v4 can be obtained also by printing a suitable mark on the continuous paper sheet p at each of the Y-color image-forming section 4Y to the K-color image-forming section 4K and detecting the printed marks.

Assuming that the elongation of the continuous paper sheet p is proportional to the difference between a let-off velocity v0, which is a conveyance velocity of the continuous paper sheet p when let off at the main driving roller 20 and the conveyance velocities of v1 to v4, elongations of e1, e2, e3, and e4, which are the elongations of the continuous paper sheet p at the Y-color image-forming section 4Y, the M-color image-forming section 4M, the C-color image-forming section 4C, and the K-color image-forming section 4K, respectively, can be obtained by the following equations:
e1=K(v1−v0)
e2=K(v2−v0)
e3=K(v3−v0)
e4=K(v4−v0)
wherein K is a constant expressing a relationship between a difference in conveyance velocities v1 to v4 and the let-off velocity v0 that is obtained experimentally.

Additionally, tension-detecting rollers can be disposed at the Y-color image-forming section 4Y and K-color image-forming section 4K in place of the velocity-detecting rollers 50 and 52 for detecting the tension t1 of the continuous paper sheet p at the Y-color image-forming section 4Y and tension t4 of the continuous paper sheet p at the K-color image-forming section 4K. The tension t2 at the M-color image-forming section 4M and the tension t3 at the C-color image-forming section 4C can be obtained from the values of the tension t1 and the tension t4. The elongations e1 to e4 can be obtained from the tensions t1 to t4 obtained by the above procedure using the above equations.

In the continuous paper sheet printer 104, based on the elongations e1 to e4 of the continuous paper sheet p, starting position of toner images can be adjusted by the following procedure:
(1) adjusting the timing for toner image-forming so as to postpone the timing for forming a toner image on the photoreceptors 40 when the elongations e1 to e4 is large;
(2) controlling magnification of a toner image formed on the photoreceptors 40 so that the toner image is formed in a larger magnification in a rotational direction of the photoreceptor 40 (i.e., the conveyance direction of the continuous paper sheet p) than in the scanning direction when the elongation e1 to e4 is large;
(3) adjusting the rotational velocity of the photoreceptors 40 so as to be proportional to the elongations e1 to e4; and
(4) printing a suitable mark on the continuous paper sheet p at the Y-color image-forming section, detecting the mark at the M-color image-forming section 4M, C-color image-forming section 4C, and the K-color image-forming section 4K, respectively, and then, adjusting the starting positions of the toner images with reference to the detected location of the mark.

Misregistration between superimposed toner images can be limited to an extremely small extent also by the continuous paper sheet printer 104.

What is claimed is:

1. An electrophotographic printing apparatus comprising:
a paper-conveying device that conveys a continuous paper sheet in a predetermined conveyance direction,
a plurality of photoreceptors disposed downstream from the paper-conveying device at same intervals in the conveyance direction of the continuous paper sheet, and
one or more idler rollers that are disposed in the conveyance direction between the paper-conveying device and the most upstream photoreceptor and that rotate passively in contact with the continuous paper sheet;
wherein the idler roller that the continuous paper sheet is in contact with at the largest wrap angle has a circumference that is equal to the whole or a fractional length of each interval between the axes of the plurality of photoreceptors.

2. The printing apparatus of claim 1, wherein the idler roller in contact with the continuous paper sheet at the largest wrap angle is a conveyance direction-changing roller changing the conveyance direction of the continuous paper sheet between the paper-conveying device and the photoreceptors.

3. The printing apparatus of claim 1, further comprising an intermediate roller that is disposed between two adjacent photoreceptors and rotates passively while contacting the continuous paper sheet, the intermediate roller having a circumference equal to the whole or a fractional length of the interval between the axes of two adjacent photoreceptors.

4. The printing apparatus of claim 2, further comprising an intermediate roller disposed between two adjacent photoreceptors and rotating passively while contacting the continuous paper sheet, the intermediate roller having a circumference equal to the whole or a fractional length of the interval between the axes of two adjacent photoreceptors.

5. An electrophotographic printing apparatus comprising:
a paper-conveying device that conveys a continuous paper sheet in a predetermined conveyance direction,
a plurality of photoreceptors disposed downstream from the paper-conveying device at same intervals in the conveyance direction of the continuous paper sheet, and
a conveyance guide member provided between the paper-conveying device and the most upstream photoreceptor and contacting the continuous paper sheet so that the continuous paper sheet is guided along a predetermined conveyance path;
wherein the side of the conveyance guide member contacting the continuous paper sheet is formed of a low-friction material wherein a friction coefficient between the low-friction material and the continuous paper sheet is lower than a friction coefficient between a driving roller incorporated by the conveying device and the continuous paper sheet.

6. The printing apparatus of claim 5, further comprising an intermediate guide member provided between two adjacent photoreceptors and contacting the continuous paper sheet to guide the continuous paper sheet along a predetermined conveyance path in contact with the continuous paper sheet,
wherein the side of the conveyance guide member contacting the continuous paper sheet is formed of a low-friction material wherein the friction coefficient between the low-friction material and the continuous paper sheet is lower than the friction coefficient between a driving roller incorporated by the conveying device and the continuous paper sheet.

7. An electrophotographic printing apparatus comprising:
a paper-conveying device conveying a continuous paper sheet in a definite conveyance direction;
a plurality of image-forming sections that form toner images and are disposed downstream from the paper-conveying device with respect to the conveyance direction of the continuous paper sheet;
an elongation-detecting device detecting elongation of the continuous paper sheet at least at the most upstream and the most downstream color image-forming sections; and
an image position-controlling device controlling the image-forming sections with reference to the elongation of the continuous paper sheet detected by the elongation-detecting device so that the toner images at each of the image-forming sections can be superimposed without misregistration.

8. The printing apparatus of claim 7, further comprising a conveyance velocity-detecting device detecting a conveyance velocity of the continuous paper sheet passing through the image-forming sections,
wherein the elongation-detecting device obtains the elongation of the continuous paper sheet based on the conveyance velocity of the continuous paper sheet detected by the conveyance velocity-detecting device.

9. The printing apparatus of claim 7, wherein the image position-controlling device controls toner image-forming position by controlling rotational velocity of a photoreceptor provided at each of the image-forming sections.

10. The printing apparatus of claim 8, wherein the image position-controlling device controls toner image-forming position by controlling rotational velocity of a photoreceptor provided at each of the image-forming sections.

11. The printing apparatus of claim 7, wherein the image position-controlling device controls toner image-forming position by controlling timing for image-forming at each image-forming section.

12. The printing apparatus of claim 8, wherein the image position-controlling device controls toner image-forming position by controlling timing for image-forming at each image-forming section.

13. The printing apparatus of claim 7, wherein the image position-controlling device controls each of the image-forming sections so as to form a toner image in larger/smaller magnification with respect to the conveyance direction when the elongation-detecting device detects a respective larger/smaller elongation of the continuous paper sheet.

14. The printing apparatus of claim 8, wherein the image position-controlling device controls each of the image-forming sections so as to form a toner image in larger/smaller magnification with respect to the conveyance direction when the elongation-detecting device detects a respective larger/smaller elongation of the continuous paper sheet.
